(19) United States
(12) Patent Application Publication
(10) Pub. No.: US 2019/0325355 A1
(43) Pub. Date: Oct. 24, 2019

(54) SYSTEM AND METHOD FOR IMPLEMENTING A CAPACITY MANAGEMENT AND LIVE USER LOCATION TOOL

(71) Applicant: JPMorgan Chase Bank, N.A., New York, NY (US)

(72) Inventors: David GLADWIN, Bournemouth (GB); Sam HAYNES, Bournemouth (GB); John Curtis TYLER, West Chester, PA (US)

(21) Appl. No.: 16/392,720

(22) Filed: Apr. 24, 2019

Related U.S. Application Data
(60) Provisional application No. 62/661,710, filed on Apr. 24, 2018.

(51) Int. Cl. G06Q 10/02; G06Q 10/06; G06Q 10/10

(52) U.S. Cl. CPC G06Q 10/02; G06Q 10/1093; G06Q 10/063114

(57) ABSTRACT

An embodiment of the present invention is directed to a capacity management and live user location tool. According to an embodiment of the present invention, live location data may be accessed from an active resource associated with a user. For example, live location data may include data from a VDI/LVDI asset that indicates that the user is logged into at a particular point and/or what port (e.g., Ethernet port) is used. An embodiment of the present invention is directed to an Application Program Interface (API) that accesses a directory and live record of assets (from floor to floor) to create a live map to identify capacity. Capacity may include what desks are free and who is sitting at what desk. An embodiment of the present invention may record this information on a day by day basis and generate capacity maps on a periodic basis, e.g., month to month, etc.

### CROSS REFERENCE TO RELATED APPLICATIONS

The application claims priority to U.S. Provisional Application 62/661,710 (Attorney Docket No. 72167.001249), filed Apr. 24, 2018, the contents of which are incorporated herein in its entirety.

### FIELD OF THE INVENTION

The invention relates generally to a system and method for capacity management and live user location.

### BACKGROUND OF THE INVENTION

Modern workspaces include common areas and open spaces instead of assigned offices. It is oftentimes difficult to determine which desks are free in a location or campus until someone shows up and look around. In other situations, when an employee wants to speak with another employee within a company, it may be difficult to find the employee. A lot of people do not know who sits beside or across from them. And, when a new hire wants to meet someone, it may be difficult to identify where that someone is without looking at the name on their phone or asking awkwardly.

These and other drawbacks exist.

### SUMMARY OF THE INVENTION

According to one embodiment, the invention relates to a system that implements a capacity management and live user location tool. The system comprises: a communications server that receives location data from a plurality of computing devices associated with an entity; a memory component configured to store employee data, location data and historical data; a capacity management engine that comprises a computer processor coupled to the communications server and the memory component, the management engine configured to perform the steps of: identify one or more assets associated with a user; retrieve location data and status data associated with the one or more assets that indicate a user location in real-time; identify supplemental data from one or more applications associated with the user; and generate a graphical display of current real-time location data for the user and a plurality of other users in a common location, wherein the graphical display provides capacity metrics for one or more other locations associated with the entity.

According to one embodiment, the invention relates to a method that implements a capacity management and live user location tool. The method comprises the steps of: identifying, via a capacity management engine, one or more assets associated with a user; retrieving, via a server, location data and status data associated with the one or more assets that indicate a user location in real-time; identifying supplemental data from one or more applications associated with the user; and generating a graphical display of current real-time location data for the user and a plurality of other users in a common location, wherein the graphical display provides capacity metrics for one or more other locations associated with the entity; wherein the capacity management engine comprises a computer processor coupled to the server and a memory, wherein the server receives location data from a plurality of computing devices associated with an entity and the memory stores employee data, location data and historical data.

The system may include a specially programmed computer system comprising one or more computer processors, interactive interfaces, electronic storage devices, and networks.

The computer implemented system, method and medium described herein provide unique advantages to entities, organizations and other users, according to various embodiments of the invention. The innovative system is directed to locating relevant individuals for a specific incident or issue and further determining availability for those individuals. The system is directed to facilitating capacity management and space usage by managing historical data and predicting usage trends and analytics. These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 illustrates a schematic diagram of a system that provides capacity management and live location data, according to an exemplary embodiment.

FIG. 2 illustrates an exemplary flowchart for capacity management, according to an embodiment of the present invention.

FIG. 3 is an exemplary flowchart for capacity management, according to an embodiment of the present invention.

FIG. 4 is an exemplary user interface of a capacity management system, according to an embodiment of the present invention.

FIG. 5 is an exemplary user interface of a capacity management system, according to an embodiment of the present invention.

### DETAILED DESCRIPTION OF THE PREFERRED EMBODIMENT(S)

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

An embodiment of the present invention is directed to a capacity management and live user location tool. Live location data may be retrieved from Active Directory data. For example, Active Directory data may represent local objects from a global catalog. In this example, objects may include what device or interface a user is using (e.g., Liquid Virtual Desktop Infrastructure (LVDI), virtual desktop or machine, physical machine, etc.), the location the device is at, whether the device is internally or externally hosted (e.g., the user is on site, working from home, travel, other office location, etc.), active time (e.g., the user is away from the keyboard) as well as general information about the user including name, email, etc. According to an embodiment of the present invention, live location data may be accessed from an active resource associated with a user. For example, live location data may include data from a VDI/LVDI asset that indicates that the user is logged into at a particular point and/or what port (e.g., Ethernet port) is used. Other indicators of live location data may be used.

An embodiment of the present invention is directed to an Application Program Interface (API) that accesses the Active Directory (e.g., employee data) and a live record of assets (from floor to floor; section to section, etc.) to create a live map that identifies capacity, status and/or other metrics. Capacity may include what desks are free and who is sitting at what desk. Status may indicate whether the employee is available (e.g., available, busy, do-not-disturb, travel, in-transmit, out of office, etc.) and/or the type of activity the user is engaged in, e.g., video conference, phone call, active in a particular application, website and/or tool, etc. Other metrics may include frequency of activity, measure of inactivity, time away from desk, etc. This information may be used to determine whether and to what extent certain applications and/or tools are utilized by employees. This information may be used for resource planning. For example, an embodiment of the present invention may identify a number of connections to access routers. An embodiment of the present invention may record this information (or a subset) on a periodic basis (e.g., day by day, etc.) and generate capacity information on a map or other interface.

An embodiment of the present invention is directed to dynamic mapping based on user logins and asset store, mapping to location, blueprint, etc. For example, blueprints for sites may be provided to allow new sites to be added with floor levels and floor plans of seat and/or asset locations. The blueprint may map ports to physical locations to direct users to different locations.

Entities may use the innovative system for capacity planning and community integration within. For example, an embodiment of the present invention may be used to determine which areas are most used and/or underutilized and further correlate this information to time of day. This may include identifying workspaces (e.g., desks, conference rooms, pods, common areas, etc.) that are not being used, which teams do not fill their neighborhoods, which neighborhoods are growing/shrinking at the highest/lowest rate, who (e.g., which team, etc.) needs more space. For example, an embodiment of the present invention may determine whether teams can fit better if they move to a different location or configuration, etc. An embodiment of the present invention may also provide trends, analytics, predictions and also provide suggestions for improved utilization of resources and better use of workspace.

A manager may use an embodiment of the present invention to locate employees/team members and access their current availability. Information may include whether they are online, logged in at a specific location (e.g., desk location, conference room, home office, travel, etc.), away from their desk and/or in transit. An embodiment of the present invention may form teams based on location and applications they work on. For example, when an incident occurs (e.g., outage, IT issue, emergency, etc.), an embodiment of the present invention may display impacted areas, degree of impact, individuals who are online, where they are located, etc. According to another example, during an emergency situation, an embodiment of the present invention may be used to account for team members, employees, etc.

An embodiment of the present invention may also integrate with campus maps. The system may provide electronic profiles and bios on current workload and projects as well as team management. An embodiment of the present invention may provide heatmaps and templates based on user roles to determine what teams work closely together and spread across an entity's hubs across a region.

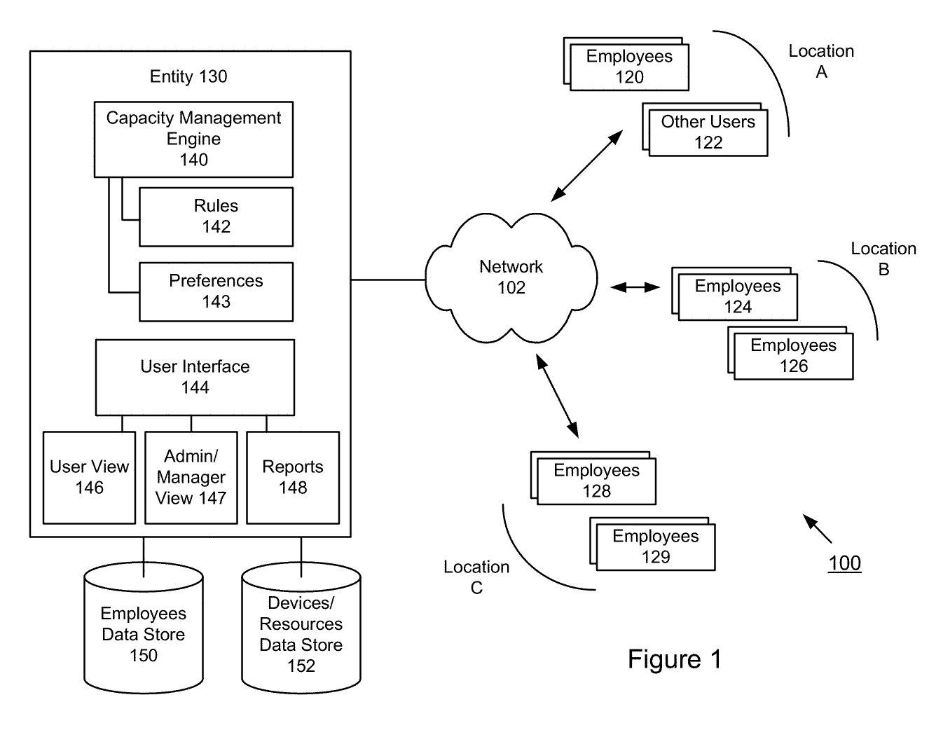

FIG. 1 illustrates a schematic diagram of a system that provides capacity management and live location data, according to an exemplary embodiment. As illustrated, Network 102 may be communicatively coupled with devices associated with various employees and other users. For example, Employees 120 and Other Users 122 may be located at Location A; Employees 124, 126 may be located at Location B and Employees 128, 129 may be located at Location C. Locations A, B, C may represent floors, sections, buildings, campuses, and/or other locations associated with an entity. The system may provide a detailed view (e.g., floor, section, etc.) as well as a global view (e.g., regional, worldwide offices).

Entity 130 may implement a Capacity Management Engine 140 that incorporates Rules 142 and Preferences 143. Rules 142 may seek to optimize resources and space configuration. Preferences 143 may manage user preferences in determining workspace availability. Preferences may include desk type, workspace specifics, equipment, proximity to team members and/or other information.

User Interface 144 may represent a display that graphical represents capacity and resource data associated with Employees and/or Users at various Locations including buildings, floors, sections, geographic areas, etc. User Interface 144 may include a User View 146 and Manager View 147. User View 146 may provide information relating to availability and resources for a current user. Manager View 147 may provide capacity management tools for capacity planning across multiple users, teams, groups, etc. User Interface 144 may support mobile application views on a mobile device as well as desktop views on a laptop or other computing device. Reports 148 may provide capacity management reports and/or other output. Reports 148 may include predictions, trends, historical data, suggestions/recommendations, etc. For example, reconfiguration suggestions may be provided in response to an optimization goal or other threshold, etc. An embodiment of the present invention may suggest sharing a workspace with employees who travel often and/or work remotely and then schedule and manage use of a common workspace.

While FIG. 1 illustrates individual devices or components, it should be appreciated that there may be several of such devices to carry out the various exemplary embodiments. Entity 130 may communicate with various entities using any mobile or computing device, such as a laptop computer, a personal digital assistant, a smartphone, a smartwatch, smart glasses, other wearables or other computing devices capable of sending or receiving network signals.

Entity 130 may access and manage data stored in various memory components, such as Data Stores 150, 152. Entity 130 may store and manage capacity data at Employees Data Store 150 (e.g., employee identification, employee historical data, etc.) and Devices/Resources Data Store 152 (e.g., laptops, mobile devices, access devices, etc.). Entity may access and/or generate reports, metrics and other analysis and outputs.

Entity 130 may be communicatively coupled to Data Stores 150, 152. Data Stores 150, 152 may include any suitable data structure to maintain the information and allow access and retrieval of the information. For example, Data Stores 150, 152 may keep the data in an organized fashion and may be an Oracle database, a Microsoft SQL Server database, a DB2 database, a MySQL database, a Sybase database, an object oriented database, a hierarchical database, a flat database, and/or another type of database as may be known in the art to store and organize data as described herein. Data Stores 150, 152 may be any suitable storage device or devices. The storage may be local, remote, or a combination thereof with respect to Data Stores 150, 152. Communications with Data Stores 150, 152 may be over a network, or communications may involve a direct connection between Data Stores 150, 152 and Entity 130, as depicted in FIG. 1. Data Stores 150, 152 may also represent cloud or other network based storage.

The system 100 of FIG. 1 may be implemented in a variety of ways. Architecture within system 100 may be implemented as hardware components (e.g., module) within one or more network elements. It should also be appreciated that architecture within system 100 may be implemented in computer executable software (e.g., on a tangible, non-transitory computer-readable medium) located within one or more network elements. Module functionality of architecture within system 100 may be located on a single device or distributed across a plurality of devices including one or more centralized servers and one or more mobile units or end user devices. The architecture depicted in system 100 is meant to be exemplary and non-limiting. For example, while connections and relationships between the elements of system 100 are depicted, it should be appreciated that other connections and relationships are possible. The system 100 described below may be used to implement the various methods herein, by way of example. Various elements of the system 100 may be referenced in explaining the exemplary methods described herein.

Network 102 may be a wireless network, a wired network or any combination of wireless network and wired network. Although Network 102 is depicted as one network for simplicity, it should be appreciated that according to one or more embodiments, Network 102 may comprise a plurality of interconnected networks, such as, for example, a service provider network, the Internet, a cellular network, corporate networks, or even home networks, or any of the types of networks mentioned above. Data may be transmitted and received via Network 102 utilizing a standard networking protocol or a standard telecommunications protocol.

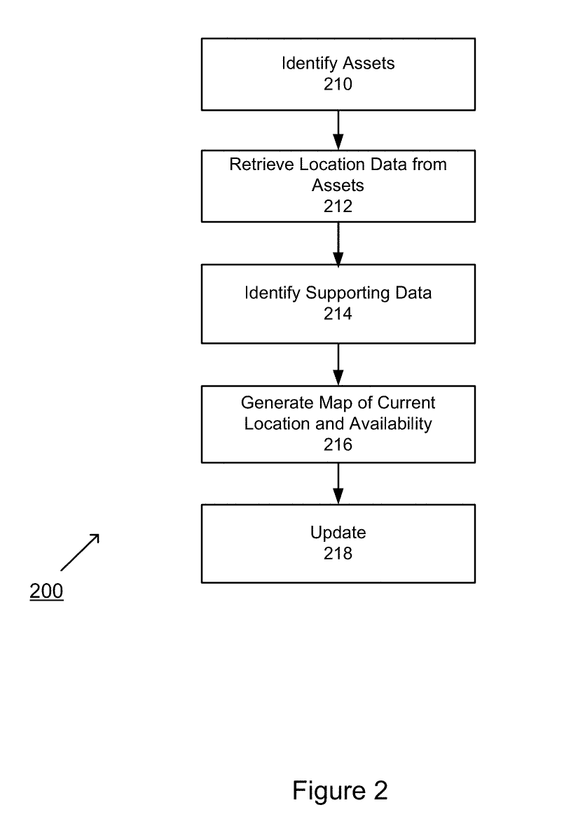

FIG. 2 illustrates an exemplary flowchart for capacity management, according to an embodiment of the present invention. At step 210, an embodiment of the present invention may identify assets associated with a user. At step 212, the system may retrieve location data associated with the assets. At step 214, the system may identify supporting data, which may include calendar/schedule data, etc. At step 216, the system may generate an interface that displays location and availability data based on the location data and supporting data. At step 218, the location data may be updated in real-time. The order illustrated in FIG. 2 is merely exemplary. While the process of FIG. 2 illustrates certain steps performed in a particular order, it should be understood that the embodiments of the present invention may be practiced by adding one or more steps to the processes, omitting steps within the processes and/or altering the order in which one or more steps are performed.

At step 210, an embodiment of the present invention may identify assets associated with a user. The assets may include computer, laptop, mobile phone and/or other resource. The system may access metadata that indicates how long the device was active, when the device was logged in, when the device was logged out, whether the device is active and time period of activity as well as other related information.

At step 212, the system may retrieve location data associated with the assets. The assets may include devices associated with a user. Location data may also be identified or inferred from other common devices that read a device associated with a user. Location data may be retrieved from a geo-location component and/or collection agent within a computer, laptop and/or other computing device. Location data may also be retrieved when the computing device is plugged in or otherwise communicating with a network or a host device. The system may also identify location data from user access data. For example, most employees are required to use an access device (e.g., RFID, sensor, tag or other device) to enter buildings, floors and other areas. This access data may also be used to support location data.

At step 214, the system may identify user specific location data, which may include calendar/schedule data. This data may be retrieved from a calendar application. For example, an employee may have a meeting scheduled in a calendar application with a conference room location. The system may confirm that the employee is actually attending the meeting in the conference room (and not by a dial-in) and use the data to confirm location data. Other supporting data may be obtained from other business applications (e.g., video conferencing applications, travel itinerary, social applications, etc.) to confirm and verify location data.

At step 216, the system may generate an interface that displays location and availability data based on the location data and supporting data. The interface may include various icons, graphics and/or interactive components that provide current location, status, activity and/or other information. Different views may be available for different types of user. For example, a user may access a User View that identifies availability information and provides the ability to claim a seat or desk location. A manager or administrator may access a Capacity Management View that provides trends, reports and/or other output to assist in capacity management functions.

At step 218, the location data may be updated in real-time. The interface may also include movement (e.g., employee movement to/away from desk locations), time clocks (e.g., when another user is scheduled to leave the desk location) and/or other interactive and real-time data. Social information may also be provided to recognize milestones, goals as well as celebrate events, e.g., birthdays, new employee, retirement, employee departures, promotions, etc. Social events may also facilitate integration and/or other team wide efforts. An embodiment of the present invention may also support geo-tags at certain locations on an interactive map. The geo-tags may indicate information and/or other events (e.g., social events, etc.).

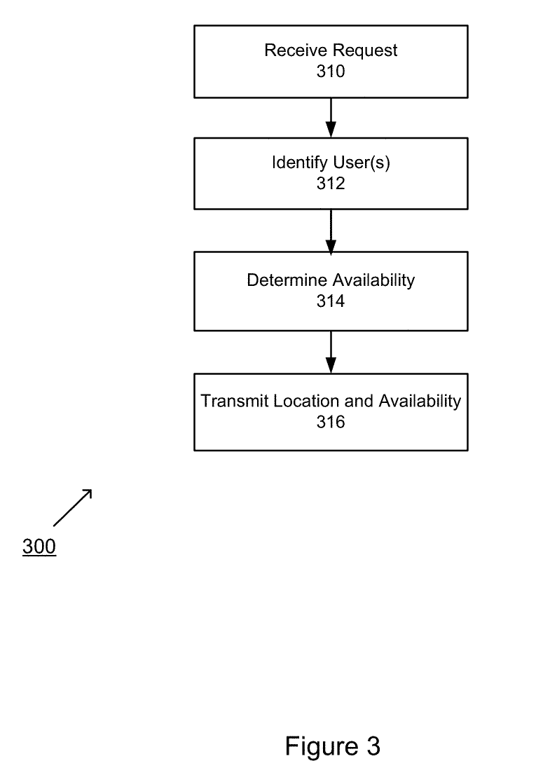

FIG. 3 is an exemplary flowchart for capacity management, according to an embodiment of the present invention. At step 310, the system may receive a request from a user. At step 312, the system may identify users associated with the request. At step 314, the system may identify corresponding availability based on real-time location and activity data. At step 316, the system may transmit location and availability information which may be provided an on interface or other format, e.g., report, etc. The order illustrated in FIG. 3 is merely exemplary. While the process of FIG. 3 illustrates certain steps performed in a particular order, it should be understood that the embodiments of the present invention may be practiced by adding one or more steps to the processes, omitting steps within the processes and/or altering the order in which one or more steps are performed.

At step 310, the system may receive a request from various types of users. Users may include a user seeking workspace availability. Users may also include users who are seeking to resolve an issue or incident. In this example, the system may be used to identify and locate the right person to address the issue or incident. Users may also include managers or administrators to perform capacity management functions.

For example, a user may seek an available workspace for a work week. The system may identify the user's preferences which may include a type of computer, type of desk (e.g., regular desk, standing desk, etc.) and/or other resources. There may be a situation where a user needs use of a computer where the user's preferences and accesses may be loaded onto a loaner computer and available for the user at a reserved workspace. The system may ensure that the workspace is compatible with the user's devices and equipment. Other information may include a secure location to store documents, laptops, etc. The system may identify a secure locker or other storage location. The system may access the user's calendar and other events to determine an optimal location as well as predicted need and/or demand for the workspace. Accordingly, an embodiment of the present invention may identify optimal workspace and resources for a user.

The request may include a request to identify location data of members of a team or other group. The request may include a search for available workspace for a period of time. The request may include a request to host or place a group of users with specific resource needs for a period of time. The request may be associated with resource availability, including workspace, specific equipment, parking spaces, etc. For example, an employee with a parking spot may be out of the office for a week. Rather than having the parking spot go unused, the space may be used for another employee based on seniority, need and/or other factors.

According to another example, the system may receive a request to resolve an incident and/or issue. In this example, the system may be integrated with an incident application. Here, the system may identify an employee that is best suited to address a specific incident. The system may identify the employee and determine status and availability and even schedule a meeting with the employee to facilitate incident resolution. Communication tools may be available including chat, VC and/or other messaging tool. The Live User Location Tool may be integrated with various applications and tools to facilitate employee and other connections.

At step 312, the system may identify users and/or resources associated with the request. Depending on the type of request, one or more users may be identified with the request. For example, an embodiment of the present invention may seek to identify one or more individuals to address an incident or issue. According to another example, a user may seek available space where specific users may not need to be identified. In other examples, a user may want to be aware of team members and/or other users. According to yet another example, a manager may seek to identify team members and activity. Other variations may be applied.

In the example of finding available workspace, an embodiment of the present invention may identify team members and/or other users relevant to the requesting user. This may include users working on a common project, members of the same team and/or other relevance to the requesting user.

At step 314, the system may identify corresponding availability based on real-time location and activity data. For example, a workplace may experience an application or other failure. When such an incident occurs, the system may facilitate finding the right individual or team and check their availability to address the issue quickly. In this example, the individual best qualified to address the application failure may be John from the middleware team who sits on the 6^{th} floor in the north campus.

According to another example, a manager or administrator may seek to generate trends data, reports and/or other compilation of capacity data. An embodiment of the present invention may also seek to identify optimal configuration data as well as other suggestions for improvement in efficiency and better utilization of resources.

At step 316, the system may transmit location and availability information which may be provided an on interface or other format, e.g., report, etc. The information may be provided via an interactive user interface and/or other output. According to another example, an embodiment of the present invention may receive a request from a user that is seeking an available workspace. In response, the system may simply direct the user to a particular floor and/or section that has the most available seating, e.g., “Proceed to the 7^{th} floor, there are 10 available workspaces.” Another embodiment of the present invention may provide reminders that indicate travel time between a current location and a meeting location. This embodiment may also consider specific floor layout and travel time between floors and/or buildings. Other variations may be realized.

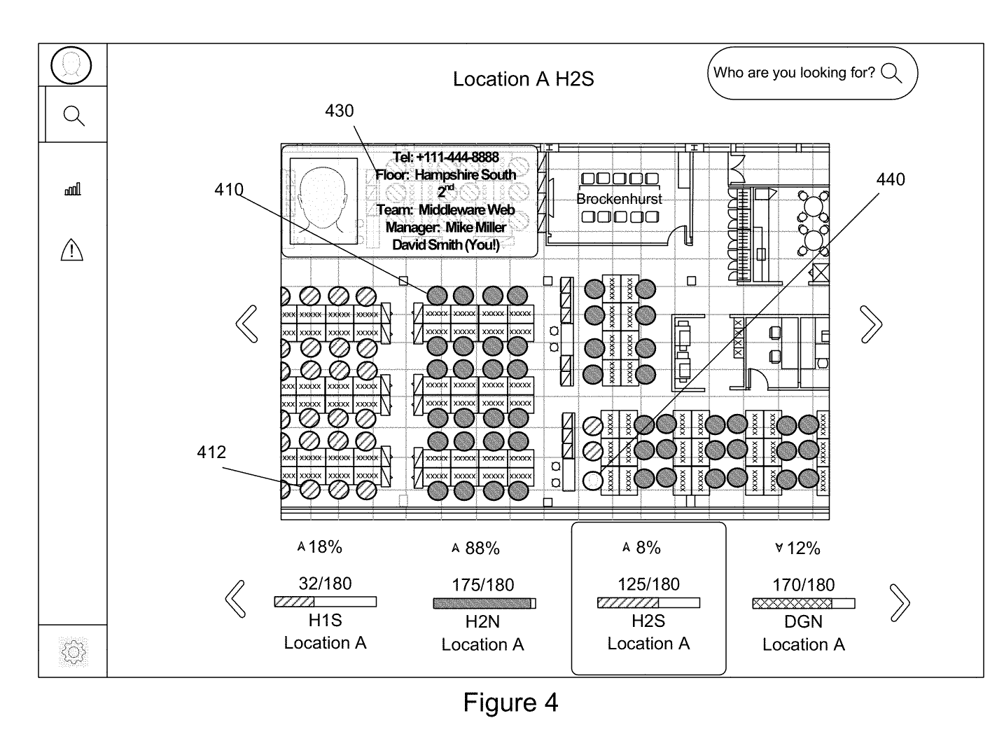

FIG. 4 is an exemplary user interface of a capacity management system, according to an embodiment of the present invention. As shown in FIG. 4, H1S, H2N, H2S and DGN represent a section of a building, e.g., floor, section, campus, corner, etc. The metrics indicate seat usage and availability. For example, at H2S, there are 125 seats used out of 180 seats. The system also indicates that this is an increase of 8% over a predetermined time period. The system captures historical data and provides trends and predictions. For example, the system may predict a likelihood of availability at a future time. According to another example, the system may analyze historical data for an employee, a group of employees as well as a team. The system may then predict where such individuals may be on a given day or time period. This type of information may be helpful in terms of capacity planning and space usage. For example, an office manager may be informed that a team from Location A is visiting Location B for two days and this team needs workspace for a team of 10 individuals where two of the team members have specific workspace requirements. The system may then identify a plurality of suggestions based on the historical data and prediction functionality. The system may also take into account vacation schedules, out of office appointments from employees at Location B as well as other relevant data from various sources.

A current employee may be shown at 440 with profile information at 430. FIG. 4 graphically illustrates workspaces that are currently occupied, such as 410, and workspaces that are empty at 412. Other graphics may indicate a do-not-disturb or busy feature. Another graphic may indicate that the employee is logged on but not currently at their workspace.

An embodiment of the present invention facilitates finding availability for specific workspaces and tracking down people. This is particularly useful for new employees and visitors.

An embodiment of the present invention provides a social aspect. The user interface may recognize certain individuals for achievements, milestones, events, birthdays, etc. For example, a new employee may be highlighted, a visiting employee may be recognized and an employee with a birthday may have a celebratory icon displayed. The system may also manage requests. For example, if worker A wants to talk to worker B, worker A may drop a request into the application and notify worker A when worker B is available.

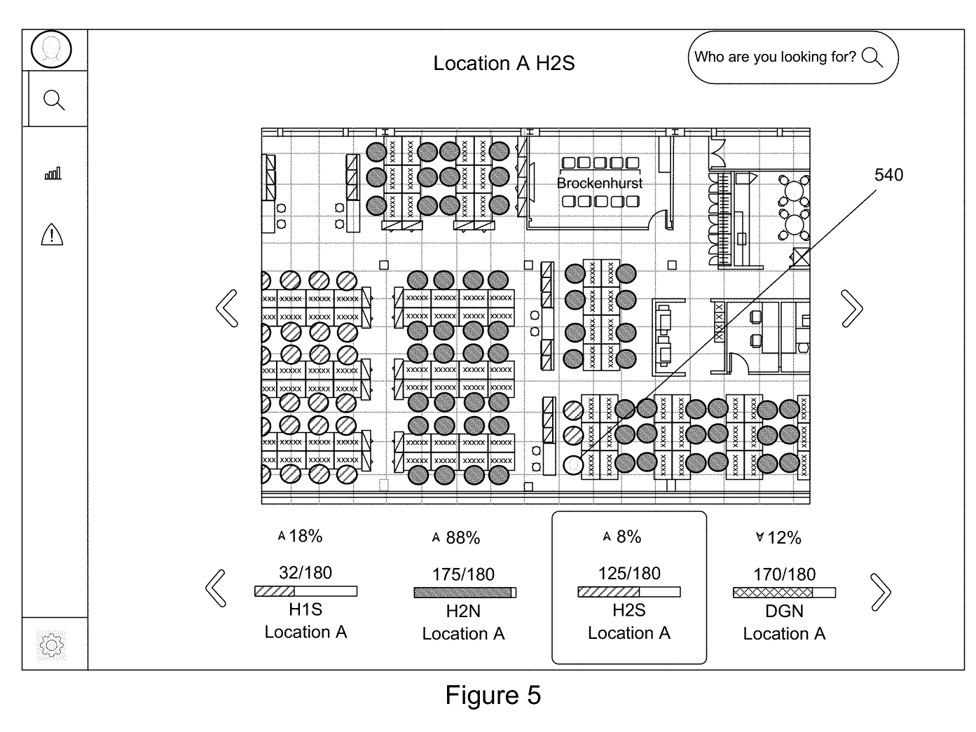

FIG. 5 is an exemplary user interface of a capacity management system, according to an embodiment of the present invention. FIG. 5 shows a full view of a selected section of a building or other location. In this example, a user 540 may view a current placement relative to the rest of the area.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

As described above, the various embodiments of the present invention support a number of communication devices and components, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, JavaScript and/or Python. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

What is claimed is:

1. A system that implements a capacity management and live location tool, the system comprising:
a communications server that receives location data from a plurality of computing devices associated with an entity;
a memory component configured to store employee data, location data and historical data;
a capacity management engine that comprises a computer processor coupled to the communications server and the memory component, the management engine configured to perform the steps of:
identify one or more assets associated with a user;
retrieve location data and status data associated with the one or more assets that indicate a user location in real-time;
identify supplemental data from one or more applications associated with the user; and
generate a graphical display of current real-time location data for the user and a plurality of other users in a common location, wherein the graphical display provides capacity metrics for one or more other locations associated with the entity.

2. The system of claim 1, wherein the graphical display comprises a user view and a manager view.

3. The system of claim 1, wherein the user view enables a user to view workspace availability.

4. The system of claim 1, wherein the user view enables a user to claim an available workspace.

5. The system of claim 1, wherein the manager view provides capacity analytics and resource utilization.

6. The system of claim 1, wherein the status data indicates user activity and the graphical display provides status data that indicates current user activity.

7. The system of claim 1, wherein the one or more applications comprise a calendar or scheduling application.

8. The system of claim 1, wherein capacity metrics comprise percentage of utilized workspaces as compared to the one or more other locations.

9. The system of claim 1, wherein location data is retrieved from a VDI/LVDI asset.

10. The system of claim 1, wherein the status data indicates one of: available, busy, do-not-disturb.

11. A method that implements a capacity management and live location tool, the method comprising the steps of:
identifying, via a capacity management engine, one or more assets associated with a user;
retrieving, via a server, location data and status data associated with the one or more assets that indicate a user location in real-time;
identifying supplemental data from one or more applications associated with the user; and
generating a graphical display of current real-time location data for the user and a plurality of other users in a common location, wherein the graphical display provides capacity metrics for one or more other locations associated with the entity;
wherein the capacity management engine comprises a computer processor coupled to the server and a memory, wherein the server receives location data from a plurality of computing devices associated with an entity and the memory stores employee data, location data and historical data.

12. The method of claim 11, wherein the graphical display comprises a user view and a manager view.

13. The method of claim 11, wherein the user view enables a user to view workspace availability.

14. The method of claim 11, wherein the user view enables a user to claim an available workspace.

15. The method of claim 11, wherein the manager view provides capacity analytics and resource utilization.

16. The method of claim 11, wherein the status data indicates user activity and the graphical display provides status data that indicates current user activity.

17. The method of claim 11, wherein the one or more applications comprise a calendar or scheduling application.

18. The method of claim 11, wherein capacity metrics comprise percentage of utilized workspaces as compared to the one or more other locations.

19. The method of claim 11, wherein location data is retrieved from a VDI/LVDI asset.

20. The method of claim 11, wherein the status data indicates one of: available, busy, do-not-disturb.
